(19) United States
(12) Patent Application Publication
(10) Pub. No.: US 2004/0082361 A1
(43) Pub. Date: Apr. 29, 2004

(54) Handeld, portable electronic computing and communication device and methods for using the same

(76) Inventor: Bala Rajagopalan, Belle Mead, NJ (US)

Correspondence Address: BALA RAJAGOPALAN, 85 KETCHAM RD, BELLE MEAD, NJ, 08502, US

(21) Appl. No.: 10/688,165

(22) Filed: Oct. 17, 2003

Related U.S. Application Data
(60) Provisional application No. 60/419,724, filed on Oct. 18, 2002.

(51) Int. Cl. H04B 5/00; H04B 1/38; H04M 1/00

(52) U.S. Cl. 455/556.1; 455/550.1; 455/41.2

(57) ABSTRACT

This invention describes a portable computing and communication device comprising a display, a touch-panel and game control input mechanisms, an optical and/or magnetic mass storage system, volatile and non-volatile primary memory, wireless data communication, power management, a compact software operating system and other software applications, and methods for using the same.

### CROSS REFERENCE TO RELATED APPLICATIONS

Provisional patent application No. 60/419,724 filed on Oct. 18, 2002.

### BACKGROUND OF INVENTION

This invention relates generally to handheld, portable electronic computing and communication systems.

The primary motivation for the present invention is the development of a portable device that is targeted for use by children in education, gaming, entertainment and communication applications. Presently, educational, entertainment and gaming applications are designed for use in full-fledged Personal Computer (PC) systems such as a desktop system. These applications tend to be rich in content, requiring the use of a large secondary storage device such as an optical Compact Disk (CD) drive. Furthermore, they are typically executed under a desktop software operating system which may require a large amount of primary memory and secondary storage. Providing the ability to execute these applications in a portable device requires: (1) incorporation of a high-capacity secondary storage mechanism directly in the device, (2) incorporation of a compact software operating system under which the applications can execute, (3) providing the suitable input/output mechanisms for executing the applications, (4) including a reasonably large display (e.g., 6.4″ diagonal), video and audio processing capabilities, and game controls, and (5) incorporation of power management functions so that the device can be operated economically using batteries.

The Internet has become an important source of multimedia content for learning and entertainment. It has also become a medium for instant communication between users. Therefore, in addition to stand-alone use, another motivation for the present invention is to use a portable device of the above nature for the retrieval of content from sources on the Internet and for Internet-based messaging. To ensure complete portability, it is required that the device must incorporate wireless communication to access the Internet.

Yet another motivation for the present invention is to use a portable device of the above nature for collaboration and control. For example, a teacher in a classroom can electronically post a problem to students' devices, and the solution worked out by each student is automatically and instantly collected using the wireless communication capability. As another example, a child can send information on his/her device to a device owned by another child using wireless communication. As a third example, a child can automatically determine which of his/her friends are present in a given locality and communicate with them using the device. Supporting these features in the portable device requires methods for coordination and control of software running in different devices from a single point, peer-to-peer communication capabilities between devices, and external servers on a local network to monitor and keep track of users in a given locality. The wireless communication feature in the portable device is integral to support all these capabilities.

Another motivation for the present invention is to use non-volatile primary memory to store software applications and personal information that can be accessed even when the secondary storage medium (e.g., CD-ROM) is removed. This makes certain software applications and information to be always available even when other more complex software applications are available only in the secondary storage.

Yet another motivation for the present invention is to support parental control and monitoring of children's activities. This requires the ability in the portable device to restrict the type of applications executed as well as the type of content accessed from external networks. This also requires the ability in the device to review the past activity, and the ability to protect this information from being removed by anyone other than the parent.

Considering prior art, portable personal computing and communication devices are now commercially available in many forms. For example, Personal Digital Assistants (PDAs) are quite popular. PDAs typically have a small form factor and hence a small display. Their built-in storage is limited, and it does not include a large-capacity medium. They are presently not suitable as a platform for executing content-rich multimedia applications with large memory requirements, or for browsing such information over the Internet.

Another type of commercially available device is the tablet PC. Tablet PCs are meant to replace laptops in certain applications and thus provide full PC functionality. They have powerful processors, large displays, wireless communication and handwriting recognition capabilities, and they are designed to dock or work in concert with a desktop system. They typically do not include an optical storage drive such as CD drive. Nor do they include game controls. Tablet PCs have the same complexity as laptop PC systems. This makes them expensive, with price approaching/exceeding that of laptop PCs. They are targeted mainly for business/professional use. Their form factor approaches that of a laptop.

Webpads are commercially available devices simpler than a full-fledged PC, but they are meant mainly for web-browsing and remote information access. They are not multi-purpose computing devices and they do not incorporate large secondary storage nor the ability to be used as an effective gaming system.

Several portable gaming devices are commercially available. These are dedicated to a single application, i.e., gaming. In the area of personal entertainment, portable CD, DVD and audio players using hard-disk storage are commercially available. Like the gaming devices, these are dedicated for a specific application. Similarly, several personal communication devices are presently available in the market. These include devices for accessing email, and mobile telephones with additional text messaging and PDA capabilities. Their use is limited to mostly accessing the wide area data service networks.

A variety of handheld computing and communication systems have been disclosed in U.S. patents. A handheld computer and data processing system is disclosed in U.S. patent application Ser. No. 2001/0004310. This system comprises an optical mass storage device and permits interactive access to information stored in a CD-ROM. This device, however, lacks features for gaming, Internet access, collaboration and control, messaging and access control. Furthermore, the usage of this device centers on the presence of the mass storage medium. Persistent primary memory and modification of personal information without the use of the mass storage is not supported.

Another handheld computer is disclosed in U.S. Pat. No. 6,381,124. This computer has capabilities similar to many commercial handheld devices. The notable features disclosed are a relatively large display (8.0 diagonal) and ruggedness of construction. This system, however, lacks a mass storage mechanism, gaming controls, and access controls.

A different multipurpose handheld computer is disclosed in U.S. Pat. No. 5,748,511. This system comprises a weather-proof housing, a bar-code reader, a printer, a relatively small keyboard and display, a mass storage mechanism and a radio link module. The form factor and the features of the device make it ideal for data collection and communication applications. It is not suitable for the primary applications addressed by the present invention.

The present invention addresses the deficiencies in prior art in meeting the requirements outlined earlier. While the primary motivation of the present invention is to develop a portable device for children's use, such a device can have other uses, for example, a portable, interactive shopping terminal, a portable information access device in factory floors, a portable entertainment and information access device for adults, a handheld controller for content distribution within a home, etc.

### SUMMARY OF INVENTION

The primary object of the invention is to provide a handheld, portable electronic computing and communication device for: (1) executing a variety of content-rich interactive multimedia applications including games and educational software, (2) playing back entertainment video and audio, (3) storing information with different forms of access control, and (4) accessing content and communicating over the Internet or a local network. The device of this invention comprises a display, a touch-panel and game control input mechanisms, an optical or a magnetic mass storage system such as a CD/DVD drive, or a hard-disk drive, volatile and non-volatile primary memory, wireless data communication, power management, a software operating system and other software applications. The device is portable in that it incorporates its own power supply, it is capable of wireless communication, its dimensions and weight allow it to be easily carried from place to place, and it can be used unobtrusively anywhere. It is handheld in that it has a small enough form factor to be held in one or both hands when in use.

The incorporation of a mass storage system allows content-rich multimedia applications to be carried in the medium, and executed under the operating system of the portable device. Such applications include educational, gaming and entertainment applications incorporating moving and still pictures, animations, audio and text. The input mechanisms allow the user to interact with these applications in different ways. For instance, using the touch-panel, the user can provide textual, free-hand, and point-and-click inputs. Using game controls the user can provide motion and selection inputs. In addition to the mass storage system, the portable device of this invention comprises volatile and non-volatile primary memory that can store software applications and personal information. The user can execute these applications and interact with them in a similar manner as described above. The device provided by this invention is of a form factor that it can be held with one or both hands when operated.

The incorporation of power management features allows the portable device to be run on commonly available batteries for prolonged periods of time. Power management implies that parts of the system that are not used for a given application are prevented from consuming power when not in use.

The portable device of this invention also comprises a wireless local area network (LAN) interface and supporting software applications that allow the user to access interactive multimedia content from the Internet and other local networks, and to perform messaging. In addition, the device comprises access control and monitoring features that allow restrictions to be imposed on the type of content and applications accessed and the activity of the user to be reviewed.

Another object of this invention is to provide methods for coordination and control of software running in multiple systems from a single point. To this end, the device of this invention supports software applications that can interact with their remote counterpart over the wireless communication interface. The remote counterpart may be running in another instance of the device provided by this invention, or it may be running in an external server. The controlling software application instance acts as the master while all the other software instances act as slaves, obeying commands from the master.

Yet another object of this invention is to provide a method for devices of this invention within communication range to automatically recognize each other's presence and enable direct communication between any pair. It is also an object of this invention to allow a server on a local network that can be used to register the presence of many devices and forward messages from one device to another when these devices cannot communicate directly.

Other objects and advantages of the present invention will become apparent from the following descriptions, taken in connection with the accompanying drawings, wherein, by way of illustration and example, embodiments of the present invention are disclosed. The deficiencies of the prior technology may be remedied by these embodiments of the present invention.

The invention is not intended to be limited to the embodiments described herein, but is instead intended to include any variations which fall within the scope of the claims. The drawings constitute a part of this specification and include an exemplary embodiment of the invention, which may be embodied in various forms. It is to be understood that in some instances various aspects of the invention may be shown exaggerated or enlarged to facilitate an understanding of the invention.

### BRIEF DESCRIPTION OF DRAWINGS

FIG. 1 depicts the frontal view of the device in one embodiment of this invention.

FIG. 2 depicts another view of the device of this invention.

FIGS. 3-6 depict three sides and the back of the device of this invention.

FIG. 7 depicts a wireless LAN transceiver attached to the device and the open CD/DVD tray.

FIG. 8 depicts one embodiment of an external game controller with an interface to the device of this invention.

FIG. 9 depicts the external game controller attached to the device of this invention.

FIG. 10 illustrates the block diagram of the hardware components of the device of this invention.

FIG. 11 depicts the functional blocks of the software architecture of the device of this invention.

FIG. 12 depicts the functional block diagram of a software application executing in one instance of the device of this invention controlling software applications executing in one or more other instances of the device.

FIG. 13 illustrates the usage of the device of this invention to access remote information using wireless communication.

### DETAILED DESCRIPTION

Detailed descriptions of the preferred embodiments are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

While the invention has been described in connection with the preferred embodiments, it is not intended to limit the scope of the invention to the particular form set forth, but on the contrary, it is intended to cover such alternatives, modifications, and equivalents as may be included within the spirit and scope of the invention as defined by the appended claims.

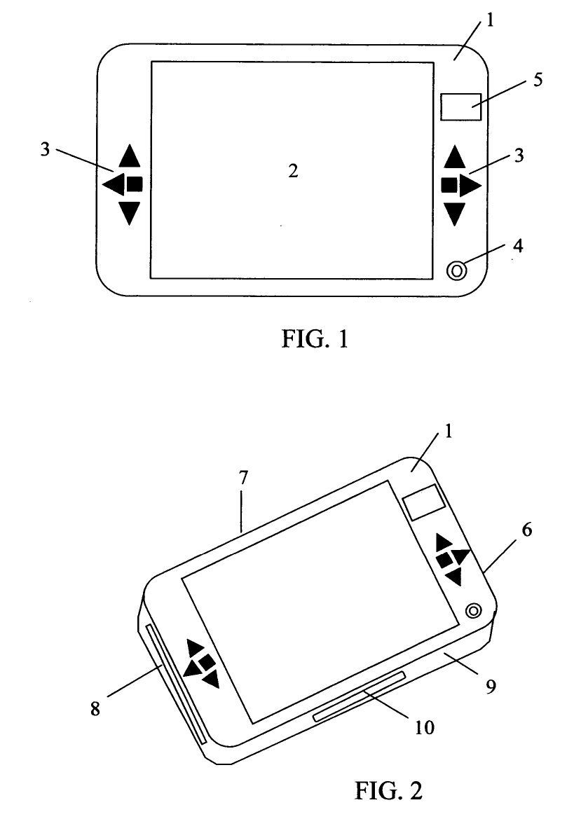

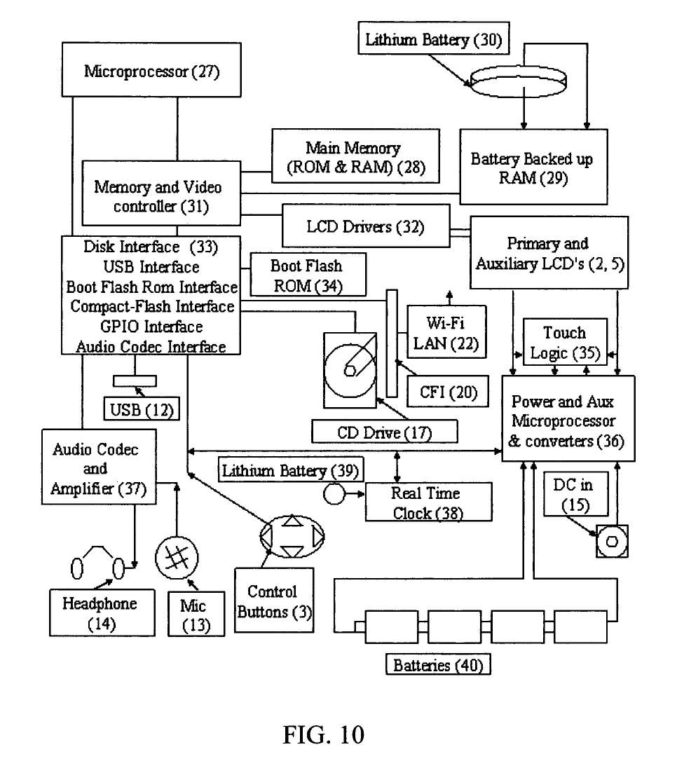

The invention generally comprises a portable computing and communication device and methods for using the same. FIG. 1 depicts the external (front) view of one embodiment of the invention. In this embodiment, the device comprises a compact rectangular housing (1) containing a processor, memory, audio codec, video controller and other hardware depicted in FIG. 10, a relatively large touch-sensitive main display (monochrome or color, at least 5 inches diagonal) (2), game control buttons (3), power on/off button (4) and a small alphanumeric or graphical auxiliary Liquid Crystal Display (LCD) (5). The auxiliary LCD is used when the device is in the stand-by mode (i.e., when not used actively), and also to display music title, track and other information when the device is used as an audio player. In these modes, the main display and other unused electronics are shut off to conserve power. The game control buttons on both sides of the housing allow the user to provide game inputs concurrently and conveniently using both hands. These buttons also allow directional motion control to be performed intuitively in the context of games. For instance, one of the left-side buttons may be used to move game characters to the left, while one of the right-side buttons may be used to move them to the right. The device in another embodiment of the invention may have a combination of a miniature joy-stick and buttons.

FIG. 2 depicts another view with the four sides of the device marked (6)-(9).

At the front side (9) is shown the interface (10) for external game controller.

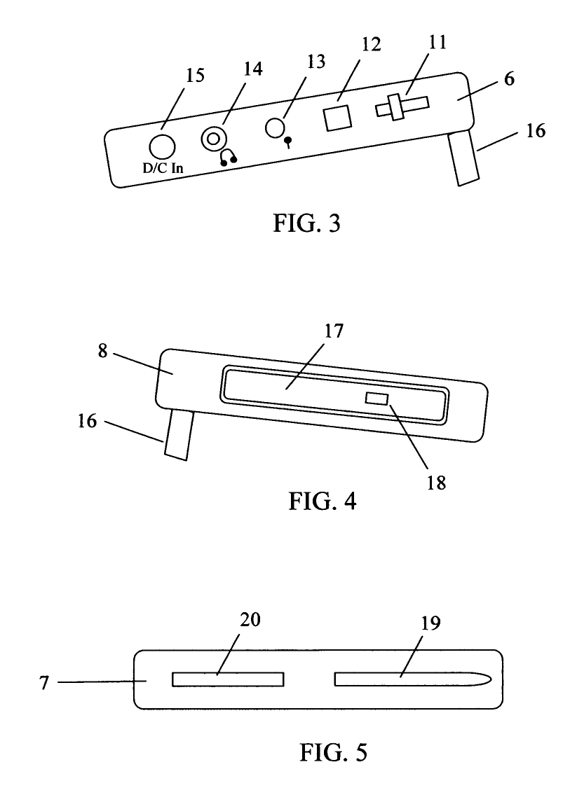

FIG. 3 depicts side (6) of the device shown in FIG. 2, comprising a sliding volume control (11), a Universal Serial Bus (USB) interface (12), audio (microphone) input (13), audio (headphone) output (14) and DC power input (15). A foldable prop (16) is also shown in this view. The device in another embodiment of the invention may have built-in speakers that augment the audio output (14), and/or a different serial interface such as FireWire (IEEE 1394) instead of the USB interface.

FIG. 4 depicts side (8) of the device shown in FIG. 2, comprising a built-in CD drive (17) with a button (18) for releasing the CD tray. The corresponding foldable prop (16) on this side is also shown. In In an alternate embodiment of the invention, a DVD drive may replace the CD drive (17) in the device. In another embodiment of the invention, an internal hard-disk drive may replace the CD drive (17) in the device. In yet another embodiment of the invention, an internal hard-disk drive, in addition to a CD or a DVD drive may be present.

FIG. 5 depicts the rear side (7) of the device shown in FIG. 2, comprising a holder for (19) a stylus (1d an interface (20) for a wireless LAN transceiver. The stylus (1 used to write on select items displayed on the touch-sensitive display (2).

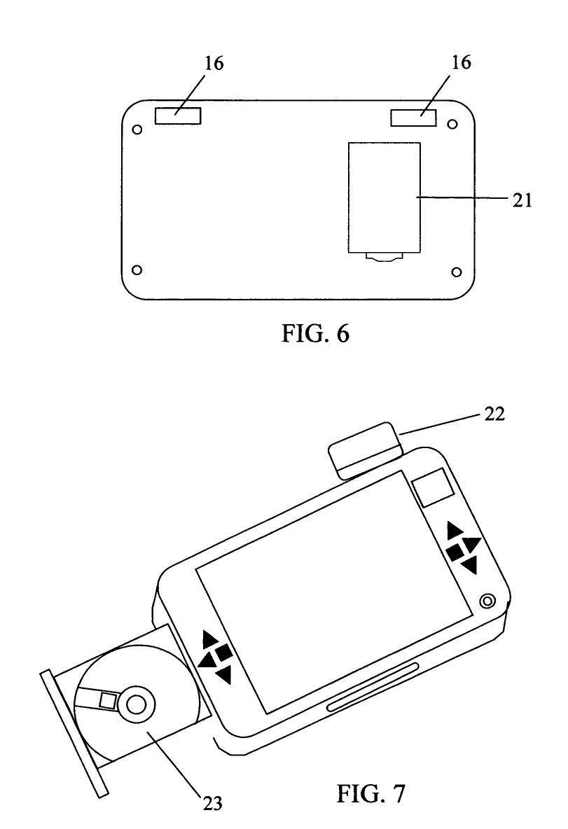

FIG. 6 depicts the bottom side of the device shown in FIG. 2, comprising a battery compartment (21) and foldable props (16).

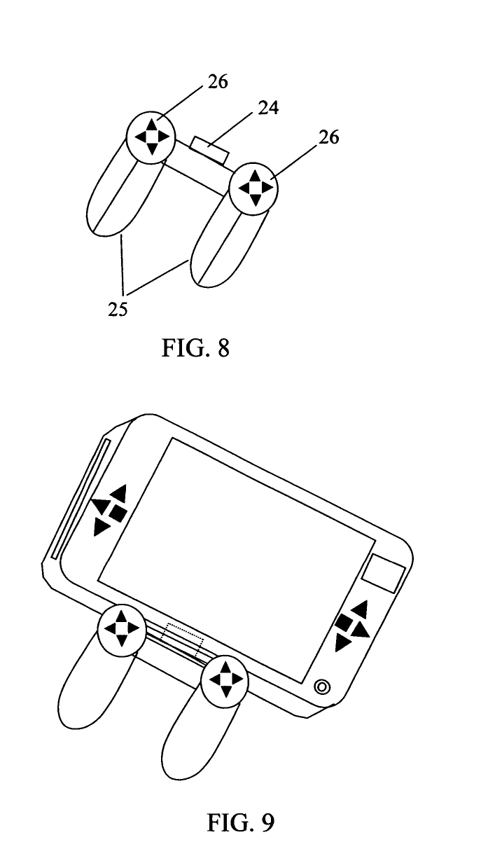

FIG. 7 depicts the device shown in FIG. 2 with a wireless LAN transceiver and antenna (22) inserted into interface (20) and the CD drive (17) kept open revealing the CD tray (23).

FIG. 8 depicts an external game controller comprising an electrical interface (24) compatible with slot (10) in the device shown in FIG. 2, hand grips (25) and game control butbuttons6).

FIG. 9 depicts the external game controller attached to the device shown in FIG. 2 by plugging interface (24) of the controller into slot (10) in FIG. 2.

FIG. 10 illustrates the functional block diagram of the system hardware corresponding to the device in the embodiment of the invention shown in FIG. 2. This figure depicts a general purpose microprocessor (27) connected to random access and read-only (main) memory (RAM and ROM) modules (28) via the memory controller (31). Non-volatile primary memory in the form of a RAM module (29) backed by a lithium battery (30) is also present to keep persistent personal information and other simple software applications. Video controller (31) connects to the LCD drivers (32) which drive the primary LCD (2) and the auxiliary LCD (5). The touch-sensitive input panel is overlaid on the primary LCD and the logic for this (35) is shown.

The processor (27) also connects to various interfaces (33), including disk, USB, boot flash ROM (34), wireless I/O, General Purpose Input/Output (GPIO) and audio codec. The compact flash interface (CFI, 20) is used to interface to the wireless LAN transceiver module (22). The disk interface is used connect to the CD drive (17). The USB interface (12) and the audio codec (37) are also shown. Audio in (microphone) jack (13) and audio out (headphone) jack (14) are connected to the latter. The control buttons (3) are connected to the GPIO interface.

Finally, the real time clock (38) is powered by battery (39). Batteries (40) and DC-in (15) are used power the device, and the corresponding power management and voltage conversion logic are depicted (36). In a different embodiment, a mini video camera may be connected to the video controller (31).

The ROM modules house the firmware, a standard or proprietary operating system and optionally, one or more resident applications such as an Internet browser. Other software applications are loaded from the CD and executed. The software applications are assumed to be compatible with the device's hardware capabilities and its operating system. The device in the present embodiment of the invention is capable of playing audio and video information encoded using different schemes and stored in a CD.

The device in another embodiment of the invention may have a DVD drive in place of the CD drive (17) depicted in FIG. 10.

The device in yet another embodiment of the invention may have a hard-disk drive in place of the CD drive (17) depicted in FIG. 10. In this case, the software applications are loaded onto the hard-disk from another system (e.g., a home PC) using the serial interface (e.g., USB, (12)).

Flash ROM or the battery-backed RAM module can be used to record user activity and maintain access control information for blocking access to certain software applications or internet content. This information may be manipulated by authorized users (e.g., parents with knowledge of pre-programmed passwords) using a ROM-resident software application. This application allows a single code to be specified by the authorized user for indicating the permitted access “level”. One method of controlling access to software applications contained in the optical storage medium (e.g., CD or DVD) is to embed the commonly used Entertainment Software Rating Board (ESRB) rating information in the medium, mapping it to an access level, and comparing it with the permitted access level programmed in the device. When a magnetic hard-disk is used as the secondary storage and software applications are downloaded into the device, the rating information can be embedded in the applications themselves. Similarly, Internet content can embed rating information, which can be mapped to an access level. Content-blocking capabilities embedded in Internet browsers are presently well-known.

Although FIG. 10 shows several functional modules, it may be possible to realize these functions by a few integrated circuits when implementing the device of this invention.

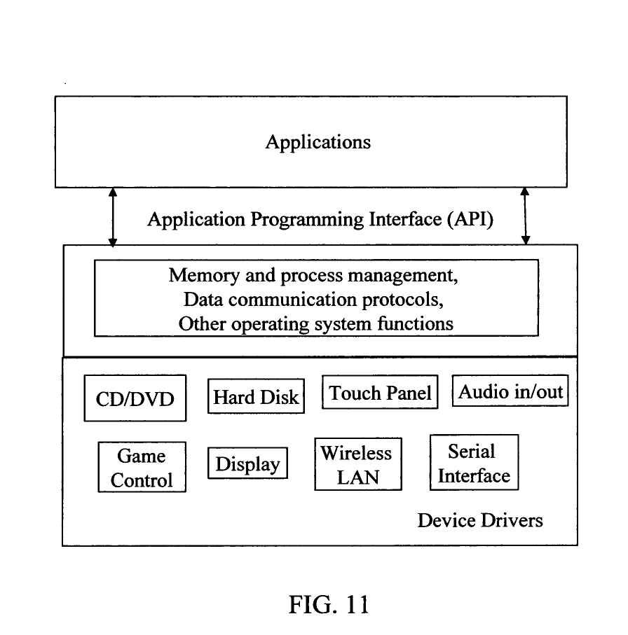

FIG. 11 illustrates the functional block diagram of the software architecture of the device in the present embodiment of the invention. This shows the software operating system comprising various device drivers, process and memory management functions, communication protocols and other operating system functions. An application-programming interface (API) allows software applications to interface to the operating system.

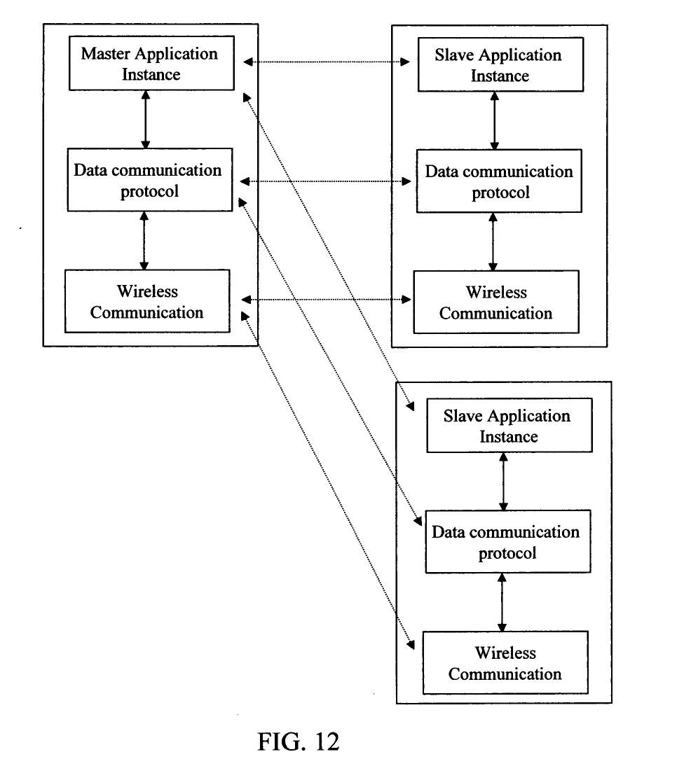

FIG. 12 illustrates the functional diagram of a software application executing in one instance of the device of this invention (referred to as the master) controlling the software executing in one or more other instances of the device of this invention (referred to as slaves). In this scenario, the software application that executes in the master sends/receives control information to/from the applications running in the slaves using data communication protocols over the wireless medium. The software applications utilize the display and input mechanisms for output/input to/from the users. The API described earlier provides the interface between the software applications and the communication protocols. Some example applications are: class-room collaboration between a teacher and students, automated collection of information stored in field workers' devices by a central server, etc. The device of this invention may also be used to support peer-to-peer collaboration between a set of users where there is no master-slave relationship between software executing in multiple instances of the device.

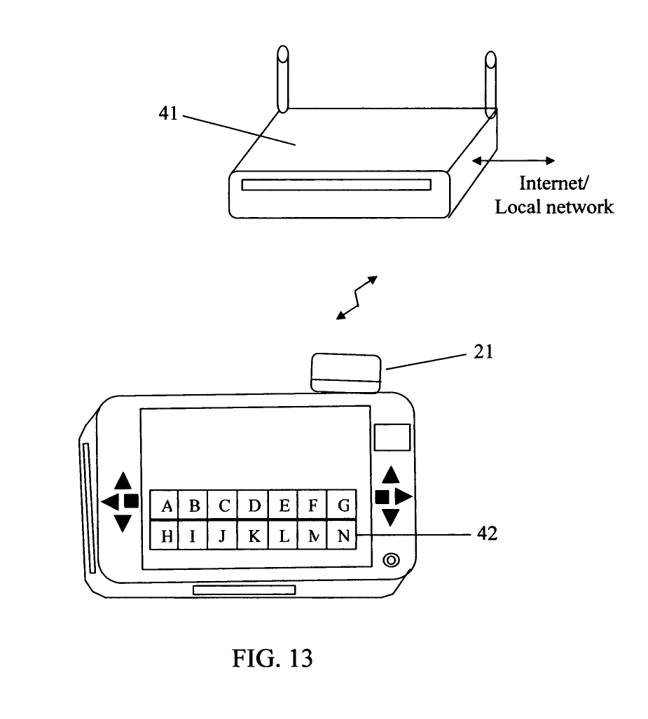

FIG. 13 illustrates the device in the embodiment of this invention, as shown in FIG. 7, acting as a browsing terminal to access remote information. A browser or other application is executed in the device to access remote information using wireless communication. It is assumed in this case that the device communicates through an external base station (41) connected to the Internet or a local network. The input mechanisms, e.g., a software-defined keyboard (42), are used to specify Universal Resource Locators (URLs) and other input information.

The communication capability illustrated in FIG. 13 can be extrapolated to the case where the device in the embodiment of this invention, as shown in FIG. 7, acts as a client for a remote server. Such a server, for instance, could be a PC or a custom device accessed via wireless communication. The server in this case provides storage and peripheral functions to the device of this invention. The user of the device could use the server to save results of a computation or other personal information. The device of this invention, in this case, is also used to retrieve the previously saved information or any other information from the server. The server could also be connected to peripherals such as a printer. In this case, the device of this invention may print locally stored information via the server.

Two instances of the device of this invention can communicate directly using the wireless communication capability illustrated in FIG. 7 and FIG. 10. Specifically, a user of an instance of the device can identify users of other instances of the device automatically using the wireless communication capability. This is done in several steps as follows: first, identification information pertaining to the user of each instance of the device is stored in the device. Second, a software application is executed in the device to broadcast the user identification periodically in a uniquely formatted message using the wireless transceiver. Finally, the same application is used to receive similar messages broadcast by devices within wireless range thereby identifying nearby users. The automatic identification feature can also be turned off if the user desires privacy.

A server on the local network could be used to provide instant messaging and presence services. In this case, a unique identifier is associated with each user of the device of this invention. When a device of this invention comes within the wireless communication range of a local network, the user identifier is registered with the server. The server then notifies users of other instances of the device of this invention about the presence of a particular user. These users could then communicate using messaging.

What is claimed is:

1. A handheld, portable electronic computing and communication device comprising:
a a compact housing, a processor, read-only and random-access primary memory, optical and/or magnetic mass secondary storage mechanism, a large touch-sensitive primary LCD, an auxiliary LCD, a battery-backed random access memory module, game control buttons for intuitive two-handed operation, high-speed serial/audio-in/audio-out/DC-in interfaces, audio and video codecs, interfaces for a wireless data communication transceiver and external game controller, battery power supply and power management logic;
a a software operating system with a well-defined application programming interface (API), a web browser application, other software applications and personal information stored in non-volatile primary memory;
a a graphical user interface for accessing personal information, commanding the execution of software applications present in primary memory or secondary storage, and for configuring and controlling the device.

2. The device of claim 1, wherein
a when used as an audio player, the primary LCD and other unused electronics are shut down and the auxiliary LCD is used for displaying information pertaining to the audio being played;
a when in the “stand-by” mode, the primary LCD and other unused electronics are shut down and the auxiliary LCD is used for displaying notification messages pertaining to device status, incoming communication requests, presence of nearby users, etc.

3. The device of claim 1, wherein the operating system or a built-in software application
a allows users with the knowledge of a pre-configured password to set a numeric or textual access level value that is protected from modification by other users;
a when the execution of a software application contained in the optical or magnetic storage medium is attempted, reads rating information embedded in the medium or the application, maps it to an access level value, compares this value with the value stored in the device, and blocks the execution of the application if the comparison indicates an impermissible access level;
a records the identity of all the applications executed and the Universal Resource Locators (URL) of all the Internet sites accessed in non-volatile memory;
a allows the recorded information to be viewed and removed only by users with the knowledge of a pre-configured password.

4. The device of claim 1, wherein wireless communication is used to
a broadcast the pre-configured identity of the user periodically (if so desired by the user) in a uniquely recognizable message and receive similar messages broadcast by other instances of the devices so as to automatically discover the identities of other users within wireless range;
a permit textual and audio communication between a pair of users who detect each other's presence automatically;
a control a software application executing in the device by another instance of the application executing remotely;
